(19) United States
(12) Patent Application Publication
(10) Pub. No.: US 2026/0304228 A1
(43) Pub. Date: Oct. 1, 2026

(54) Distributed Non-Access Stratum Termination

(71) Applicant: Apple Inc., Cupertino, CA (US)

(72) Inventors: Behrouz Aghili, Poway, CA (US); Sudeep Manithara Vamanan, Uttenreuth (DE); Peng Cheng, Beijing (CN); Ralf Rossbach, Munich (DE)

(21) Appl. No.: 19/479,236

(22) PCT Filed: Jun. 26, 2023
(86) PCT No.: PCT/CN2023/102346

§ 371 Date: Oct. 27, 2025

(51) Int. Cl. H04W 28/12; H04W 36/00

(52) U.S. Cl. CPC H04W 28/12; H04W 36/0033

(57) ABSTRACT

This disclosure relates to techniques for performing wireless communication in a system with distributed non-access stratum termination. A radio access network element may receive information from a wireless device indicating that network-side non-access stratum termination for the wireless device can be distributed. The radio access network element may provide an indication to a core network anchor node that network-side non-access stratum termination for the wireless device can be distributed. The radio access network element may receive mobility management context information for the wireless device from the core network anchor node, which may include addressing information for one or more other core network nodes. The radio access network element may receive uplink data from the wireless device, and may forward the uplink data directly to at least one other core network node using the addressing information included in the mobility management context information for the wireless device.

### FIELD

The present application relates to wireless communications, and more particularly to systems, apparatuses, and methods for performing wireless communication in a wireless communication system with distributed non-access stratum termination.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1xRTT, 1xEV-DO, HRPD, eHRPD), IEEE 802.11 (WLAN or Wi-Fi), BLUETOOTH™, etc.

The ever-increasing range of features and functionality introduced in wireless communication devices also creates a continuous need for improvement in both wireless communications and in wireless communication devices. In particular, as wireless networks are expecting to handle increasing amounts of traffic, it is important to ensure that network architecture designs can effectively and efficiently handle that traffic. Accordingly, improvements in the field are desired.

### SUMMARY

Embodiments are presented herein of apparatuses, systems, and methods for performing wireless communication in a wireless communication system with distributed non-access stratum termination.

According to the techniques described herein, it may be possible for core network anchor nodes to offload at least a portion of non-access stratum termination and corresponding processing and signaling loads to radio access network nodes, which may help more evenly distribute such loads among network elements.

As one such possibility, a radio access network node may be configured to handle lightweight mobility management operations, for example for wireless devices with limited or no mobility and that access a limited set of services. Such a radio access network node, and/or a core network anchor node supporting the radio access network node, may be able to recognize when a wireless device may be suitable for such non-access stratum termination distribution, for example based on wireless device type information, service type information for services requested by the wireless device, or other types of indications.

For such a wireless device, the core network anchor node may provide at least some context information for the wireless device to the radio access network node. Using this context information, the radio access network node may be able to provide at least limited non-access stratum termination functionality by handling uplink and/or downlink control plane data routing for supported services for the wireless device.

Note that the techniques described herein may be implemented in and/or used with a number of different types of devices, including but not limited to radio access network elements such as base stations, core network elements, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 illustrates an exemplary block diagram of a network element, according to some embodiments;

FIG. 6 is a flowchart diagram illustrating aspects of an exemplary possible method for performing wireless communication in a system with distributed non-access stratum termination, according to some embodiments;

FIG. 7 illustrate exemplary aspects of a possible control plane stack between a wireless device and a cellular core network, according to some embodiments;

FIG. 8 is a signal flow diagram illustrating exemplary aspects of a possible signal flow for performing uplink communication in a system with distributed non-access stratum termination, according to some embodiments; and

FIGS. 9-10 are signal flow diagram illustrating exemplary aspects of possible signal flows for performing downlink communication in a system with distributed non-access stratum termination, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
TRP: Transmission-Reception-Point

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well as any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

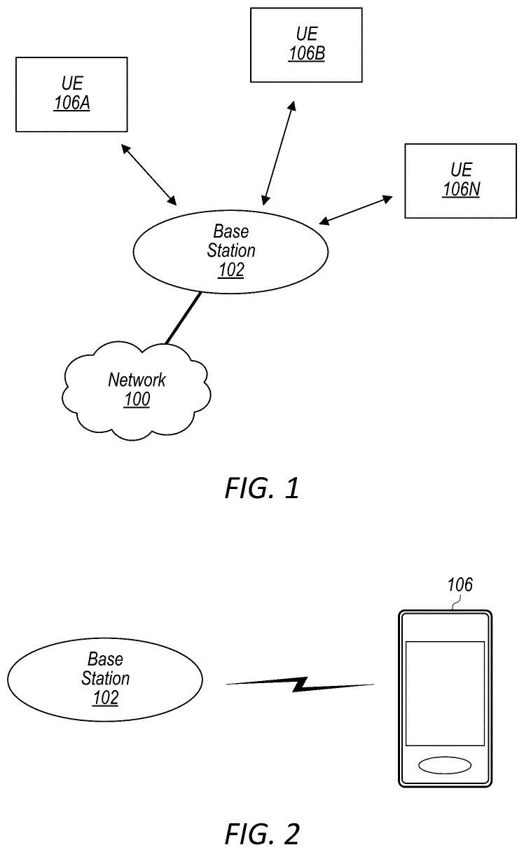

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. In some embodiments, it may be possible that the base station 102 includes 3GPP 6^{th} generation (6G) radio access network (RAN) node functionality. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

Note that, at least in some 3GPP contexts, base station functionality can be split, for example between any or all of centralized units (CUs), distributed units (DUs), and radio units (RUS). The illustrated base station 102 may support the functionality of any or all of a CU, a DU, or a RU, in such a network deployment context, at least according to some embodiments. In some instances, the base station 102 may be configured to act as an integrated access and backhaul (IAB) donor (e.g., including IAB donor CU and/or IAB donor DU functionality). In some instances, the base station 102 may be configured to act as an IAB node (e.g., including IAB mobile termination (MT) and IAB-DU functionality). Other implementations are also possible.

The base station 102 and the user devices may be configured to communicate over the transmission medium using any of various radio access technologies (RATs), also referred to as wireless communication technologies, or telecommunication standards, such as LTE, LTE-Advanced (LTE-A), LAA/LTE-U, 5G NR, Wi-Fi, etc. In some embodiments, at least some 3GPP 6G based communication techniques may be used to communicate over the transmission medium.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform techniques for performing wireless communication in a system with distributed non-access stratum termination, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, an unmanned aerial vehicle (UAV), an unmanned aerial controller (UAC), an automobile, an automation or control device, a measurement or sensor device, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of LTE, LTE-A, 5G NR, Wi-Fi, BLUETOOTH™, or GNSS. In some embodiments, UE 106 may be capable of operating as a 3GPP 6G wireless device, or may potentially be capable of performing at least some 3GPP 6G based communication techniques. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for multiple-input, multiple-output or “MIMO”) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include any number of antennas and may be configured to use the antennas to transmit and/or receive directional wireless signals (e.g., beams). Similarly, the BS 102 may also include any number of antennas and may be configured to use the antennas to transmit and/or receive directional wireless signals (e.g., beams). To receive and/or transmit such directional signals, the antennas of the UE 106 and/or BS 102 may be configured to apply different “weight” to different antennas. The process of applying these different weights may be referred to as “precoding”.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or NR, and separate radios for communicating using each of Wi-Fi and BLUETOOTH™. Other configurations are also possible.

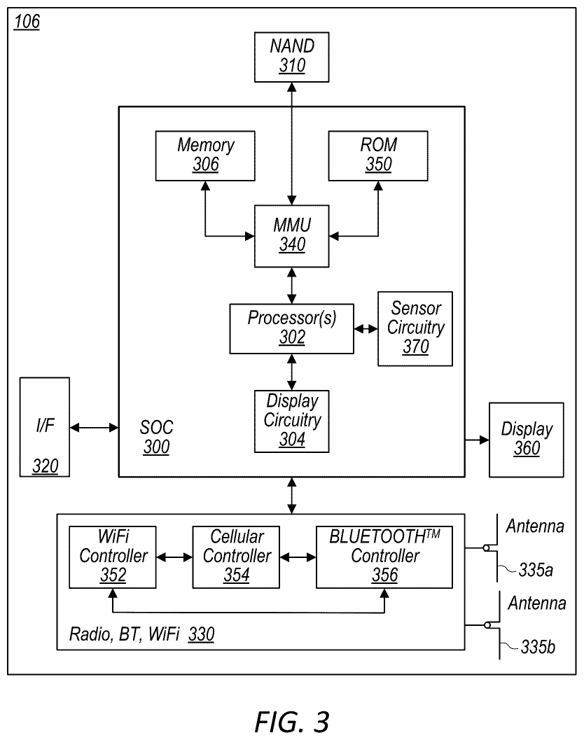

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. Some or all of the various illustrated components (and/or other device components not illustrated, e.g., in variations and alternative arrangements) may be “communicatively coupled” or “operatively coupled,” which terms may be taken herein to mean components that can communicate, directly or indirectly, when the device is in operation.

As shown, the SOC 300 may include processor(s) 302 which may execute program instructions for the UE 106 and display circuitry 304 which may perform graphics processing and provide display signals to the display 360. The SOC 300 may also include sensor circuitry 370, which may include components for sensing or measuring any of a variety of possible characteristics or parameters of the UE 106. For example, the sensor circuitry 370 may include motion sensing circuitry configured to detect motion of the UE 106, for example using a gyroscope, accelerometer, and/or any of various other motion sensing components. As another possibility, the sensor circuitry 370 may include one or more temperature sensing components, for example for measuring the temperature of each of one or more antenna panels and/or other components of the UE 106. Any of various other possible types of sensor circuitry may also or alternatively be included in UE 106, as desired. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, BLUETOOTH™, Wi-Fi, GPS, etc.). In some embodiments, UE 106 may be capable of operating as a 3GPP 6G wireless device, or may potentially be capable of performing at least some 3GPP 6G based communication techniques. The UE device 106 may include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. The communication circuitry may include multiple receive chains and/or multiple transmit chains for receiving and/or transmitting multiple spatial streams, such as in a multiple-input multiple output (MIMO) configuration. As noted above, the UE may be configured to communicate wirelessly using multiple wireless communication standards in some embodiments.

The UE 106 may include hardware and software components for implementing methods for the UE 106 to perform wireless communication in a wireless communication system with distributed non-access stratum termination, such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform wireless communication in a wireless communication system with distributed non-access stratum termination according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g., LTE and/or NR, controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

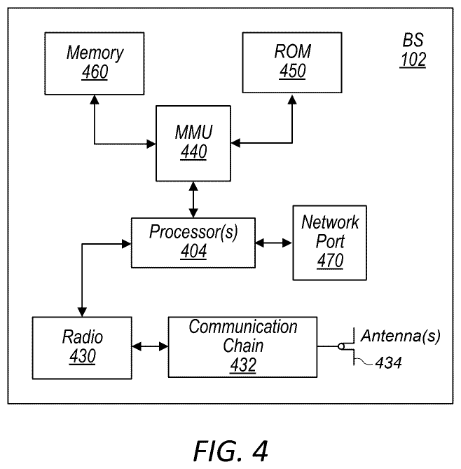

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transmission and reception points (TRPs). In addition, a UE capable of operating according to 5G NR may be connected to one or more TRPs within one or more gNBs. In some embodiments, base station 102 may be capable of operating as a 3GPP 6G radio access network node, or may potentially be capable of performing at least some 3GPP 6G based communication techniques.

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, 5G NR, 5G NR SAT, LTE, LTE-A, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, 5G NR SAT and Wi-Fi, LTE and Wi-Fi, etc.).

As described further subsequently herein, the BS 102 may include hardware and software components for implementing or supporting implementation of features described herein. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network(s), e.g., it may include at least one Ethernet port, and radio 430 may be designed to communicate according to the Wi-Fi standard.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

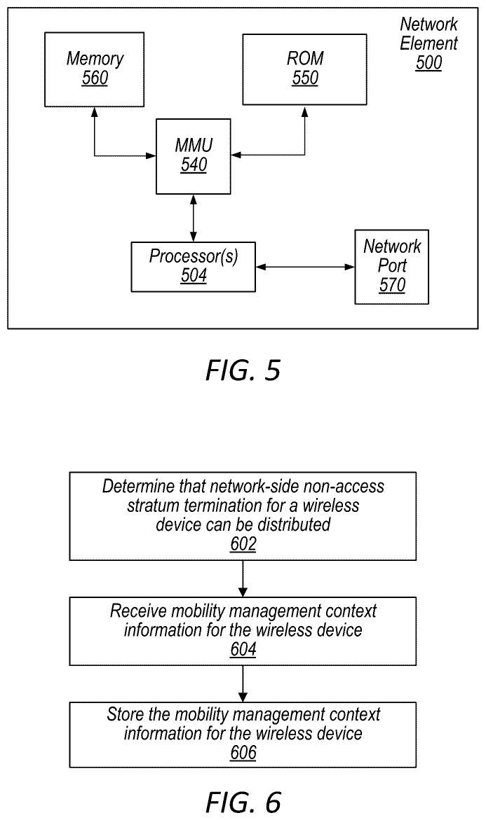

### FIG. 5—Exemplary Block Diagram of a Network Element

FIG. 5 illustrates an exemplary block diagram of a network element 500, according to some embodiments. According to some embodiments, the network element 500 may implement one or more logical functions/entities of a cellular core network, such as a mobility management entity (MME), serving gateway (S-GW), access and management function (AMF), session management function (SMF), etc. In some embodiments, network element 500 may be capable of operating as a 3GPP 6G network node, or may potentially be capable of performing at least some 3GPP 6G based communication techniques. It is noted that the network element 500 of FIG. 5 is merely one example of a possible network element 500. As shown, the core network element 500 may include processor(s) 504 which may execute program instructions for the core network element 500. The processor(s) 504 may also be coupled to memory management unit (MMU) 540, which may be configured to receive addresses from the processor(s) 504 and translate those addresses to locations in memory (e.g., memory 560 and read only memory (ROM) 550) or to other circuits or devices.

The network element 500 may include at least one network port 570. The network port 570 may be configured to couple to one or more radio access network elements and/or other cellular network entities and/or devices. The network element 500 may communicate with radio access network elements (e.g., eNBs/gNBs/etc.) and/or other network entities/devices by means of any of various communication protocols and/or interfaces.

As described further subsequently herein, the network element 500 may include hardware and software components for implementing and/or supporting implementation of features described herein. The processor(s) 504 of the core network element 500 may be configured to implement or support implementation of part or all of the methods described herein, e.g., by executing program instructions stored on a memory medium (e.g., a non-transitory computer-readable memory medium). Alternatively, the processor 504 may be configured as a programmable hardware element, such as an FPGA (Field Programmable Gate Array), or as an ASIC (Application Specific Integrated Circuit), or a combination thereof.

### FIG. 6—Distributed Non-Access Stratum Termination

As the amount of wireless traffic in cellular networks grows, including encompassing an increasingly broad range of types devices and communication being performed, there is potential for the processing and signaling burden on centralized network functionality to become undesirably large. Accordingly, as wireless communication technologies evolve and undergo continued development, there may be significant benefits to designing techniques for distributing at least some portion of network functionality more broadly.

One possible aspect of such distribution could include distributing certain aspects of network functionality that are currently handled in core network nodes to radio access network nodes. For example, it may be beneficial to specify techniques for supporting distribution of at least some non-access stratum functionality more broadly among cellular network elements, at least in some instances. To illustrate one such set of possible techniques, FIG. 6 is a flowchart diagram illustrating a method for performing wireless communication in a wireless communication system with distributed non-access stratum termination, at least according to some embodiments.

Aspects of the method of FIG. 6 may be implemented by a wireless device, e.g., in conjunction with one or more cellular network elements, such as a UE 106, a BS 102, and/or network element 500 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 6 are described in a manner relating to the use of communication techniques and/or features associated with 3GPP specification documents, such description is not intended to be limiting to the disclosure, and aspects of the method of FIG. 6 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 6 may operate as follows.

The wireless device may establish a wireless link with a radio access network node, such as a cellular base station. According to some embodiments, the wireless link may include a cellular link according to 5G NR. For example, the wireless device may establish a session with an AMF entity of the cellular network by way of one or more gNBs that provide radio access to the cellular network. As another possibility, the wireless link may include a cellular link according to LTE. For example, the wireless device may establish a session with a mobility management entity of the cellular network by way of an eNB that provides radio access to the cellular network. Other types of cellular links are also possible (e.g., a 6G based cellular link), and the cellular network may also or alternatively operate according to another cellular communication technology, according to various embodiments.

Note that, at least in some embodiments, the radio access network (RAN) may itself include multiple types of elements or nodes, for example including one or more centralized units (CUs), distributed units (DUs), and/or radio units (RUs), which may operate together to handle various aspects of radio access network operation, such as providing an air interface to wireless devices served by the RAN, control plane signal routing, user plane signal routing, etc. Thus, at least in some instances, the wireless device establishing the wireless link with a RAN element that provides an air interface may effectively also be forming one or more communication paths with other RAN elements in the cellular network.

Establishing the wireless link may include establishing a RRC connection between the wireless device and the cellular network, at least according to some embodiments. Establishing the RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons. Note that it may be possible that (e.g., 3GPP 6G based) variations or alternatives to establishing a RRC connection may alternatively or additionally be used for performing registration, establishing various contexts (e.g., security, mobility), etc., between the wireless device and the cellular network, in some embodiments.

At least according to some embodiments, the wireless device may establish multiple wireless links, e.g., with multiple TRPs of the cellular network, according to a multi-TRP configuration. In such a scenario, the wireless device may be configured (e.g., via RRC signaling) with one or more transmission control indicators (TCIs), e.g., which may correspond to various beams that can be used to communicate with the TRPs. Further, it may be the case that one or more configured TCI states may be activated by media access control (MAC) control element (CE) for the wireless device at a particular time.

At least in some instances, establishing the wireless link(s) may include the wireless device providing capability information for the wireless device. Such capability information may include information relating to any of a variety of types of wireless device capabilities.

It may be the case that the cellular network is capable of supporting network-side distributed non-access stratum (NAS) termination for certain device types and/or services. For example, certain RAN elements may be capable of supporting a light version of mobility management functionality for devices with limited or no expectation of mobility, and/or for devices that are primarily or exclusively performing uplink transmissions for control plane based services. Such functionality may be sufficient for certain Internet of Things (IoT) use cases, for example including stationary- or nomadic-deployed measurement or sensor devices, among various other possible use cases. Note that other scenarios, in which RAN elements may be capable of supporting distributed NAS termination to a greater, lesser, or otherwise different scale, are also possible.

In 602, a RAN element may determine that network-side NAS termination for a wireless device can be distributed. This determination may be based on information received from the wireless device, which may be indicative to the RAN element that network-side NAS termination for the wireless device can be distributed. At least in some instances, the information may include an indication of a device type of the wireless device and/or one or more service types requested by the wireless device. In various embodiments, this could include any of a variety of types of information, for example depending on for which types of devices and/or services the network is capable of supporting network-side distributed NAS termination. Further, this information could be provided in any of a variety of ways (e.g., using different types of signaling or messages). Provision of this information by the wireless device could be triggered by mobile originated (MO) traffic, for example including when the wireless device initiates establishing a connection with the RAN element to transmit uplink data, or by mobile terminated (MT) traffic, for example including when the wireless device receives a paging notification indicating to establish a connection with the RAN element to receive downlink data, in various embodiments.

As one possibility, the wireless device may use a random access preamble that is associated (e.g., at least by the RAN element) with network-side distributed NAS termination support. For example, the random access preamble used by the wireless device to initiate establishing a radio resource control (RRC) connection could be a preamble selected from a set of preambles that are dedicated for a device type and/or service type for which the RAN element knows the network supports distributed NAS termination. In such a scenario, the association of the random access preamble with network-side distributed NAS termination support may be considered implicit. Alternatively, the preamble could be selected from a set of preambles that are explicitly configured to indicate suitability for network-side distributed NAS termination.

As another possibility, the wireless device may include information in a radio resource control setup request that is associated (e.g., at least by the RAN element) with network-side distributed NAS termination support. For example, the logical channel identity (LCID) indicated by the wireless device when setting up the RRC connection could be selected from a set of LCIDs that are dedicated for a device type and/or service type for which the RAN element knows the network supports distributed NAS termination. In such a scenario, the association of the LCID with network-side distributed NAS termination support may be considered implicit. Alternatively, the LCID could be selected from a set of LCIDs that are explicitly configured to indicate suitability for network-side distributed NAS termination. The wireless device could additionally or alternatively include a special radio network temporary identifier associated with network-side distributed NAS termination support, or RRC establishment cause information associated with network-side distributed NAS termination support, among various possibilities for providing the information indicative to the RAN element that network-side NAS termination for the wireless device can be distributed.

As a still further possibility, the wireless device may include information in a registration or service request that is associated (e.g., at least by the RAN element) with network-side distributed NAS termination support. For example, device type and/or service type indicated by the wireless device when requesting registration or a service may be for a device type and/or service type for which the RAN element can determine that the network supports distributed NAS termination for the wireless device. In such a scenario, it may be the case that the association of the wireless device type and/or service type with network-side distributed NAS termination support may be considered implicit. Alternatively, the wireless device type information and/or service type information could be explicitly configured to indicate suitability for network-side distributed NAS termination. In some embodiments, the wireless device may provide wireless device capability information to indicate the wireless device type information or otherwise to provide information from which the RAN element can determine that network-side NAS termination can be distributed for the wireless device.

The RAN element may provide an indication to a core network anchor node (e.g., a mobility anchor node, such as an AMF) that network-side NAS termination for the wireless device can be distributed. The indication may include forwarding the information received from the wireless device based on which the RAN element determined that network-side NAS termination for the wireless device can be distributed. Alternatively, or additionally, the RAN element may provide one or more other explicit or implicit types of indication that network-side NAS termination for the wireless device can be distributed. In some embodiments, the indication from the RAN element to the core network anchor node may include an indication of wireless device type and/or requested service type that is provided in a registration request or service request for the wireless device. The core network anchor node may determine, based at least in part on the indication, that network-side NAS termination for the wireless device can be distributed.

The core network anchor node may establish context information (e.g., mobility management, security, and/or other context information) for the wireless device, for example as part of registration of the wireless device. In 604, the RAN element may receive at least a portion of the context information for the wireless device from the core network anchor node. The core network anchor node may provide some or all of the context information (e.g., including at least some mobility management context information) to the RAN element, e.g., based at least in part on determining that network-side NAS termination for the wireless device can be distributed. In some embodiments, the mobility management context information provided to the RAN element may include any or all of wireless device identity information, wireless device security context information, type of service information for one or more services requested by the wireless device, and/or core network node address information for one or more core network nodes associated with the service(s) requested by the wireless device. Providing the mobility management context information to the RAN element may allow the RAN element to assume some or all (e.g., depending on RAN element and other network element capabilities) aspects of NAS termination for the wireless device, at least in some embodiments.

In 606, the RAN element may store the context information for the wireless device. The context information may be stored while the wireless device remains registered with the core network anchor node and in the service area of the RAN element, in some embodiments. The context information may be used by the RAN element to support at least a portion of NAS termination functionality for the wireless device. For example, the RAN element may be able to receive control plane uplink data for certain supported services from the wireless device, and to forward or otherwise route the control plane uplink data to the appropriate core network node using the mobility management context information for the wireless device, which may include addressing information for that core network node. As another example, the RAN element may be capable of supporting certain NAS termination procedures, such as service request procedure completion. Thus, the RAN element could potentially receive a service request message from the wireless device, determine that the RAN element supports NAS termination for the service(s) requested by the service request message, and generate and transmit a service accept message directly (e.g., without forwarding the service request message to the core network anchor node) to the wireless device in response to the service request message. Support for other NAS termination procedures at the RAN element are also possible.

It may also be possible that the core network can send buffered downlink data to the wireless device via the control plane, including making use of the mobility management context information and distributed NAS termination functionality at the RAN element. For example, the RAN element may receive and buffer control plane downlink data for the wireless device from the core network anchor node, then (e.g., potentially without any further involvement with the core network anchor node) to perform paging, handle a service request from the wireless device, and provide downlink NAS transport for the control plane downlink data.

Note that if the RAN element receives control plane uplink data for which it is not capable of assuming NAS termination, it may be the case that the RAN element can determine that it does not support NAS termination for the control plane uplink data, and can forward the control plane uplink data to the core network anchor node, e.g., for NAS termination and routing therefrom. Similarly, in a scenario in which the RAN element supports only a limited set of NAS termination functionality (e.g., procedure handling capability), the RAN element may still be capable of forwarding messages to the core network anchor node, which may be capable of providing the NAS termination functionality not supported by the RAN element.

Note also that user plane data can be handled separately and in any of various ways, at least in some embodiments, for example including using any of various existing user plane data handling techniques, among various possibilities.

Thus, at least according to some embodiments, the method of FIG. 6 may be used to provide a framework according to which a cellular network can support distributed non-access stratum termination, which may in turn help reduce core network signaling and processing load, at least in some instances.

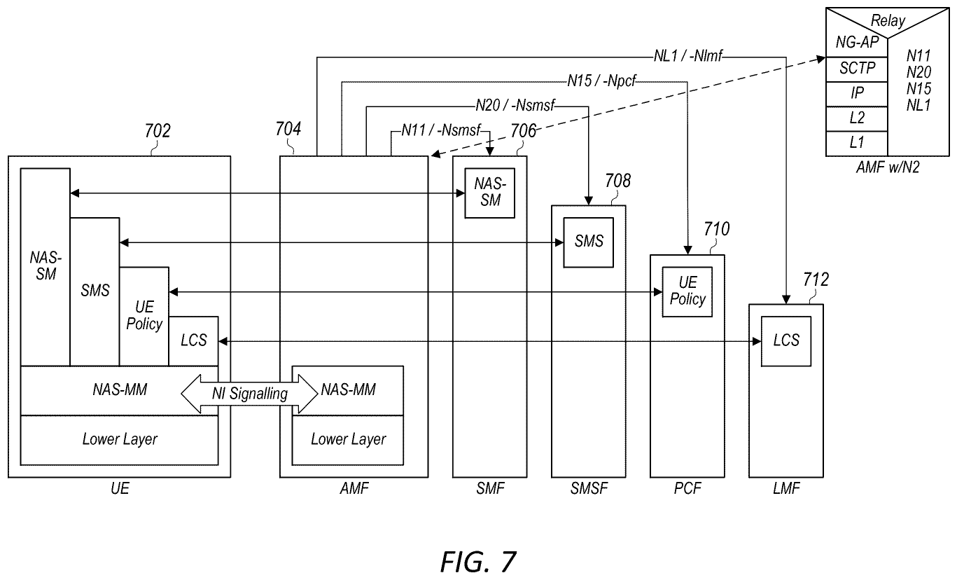

### FIGS. 7-10 and Additional Information

FIGS. 7-10 illustrate further aspects that might be used in conjunction with the method of FIG. 6 if desired. It should be noted, however, that the exemplary details illustrated in and described with respect to FIGS. 7-10 are not intended to be limiting to the disclosure as a whole: numerous variations and alternatives to the details provided herein below are possible and should be considered within the scope of the disclosure.

In a 3GPP 5G core network, it may be the case that mobility management (MM) protocols are handled in a monolithic block including multiple levels of functionality. While multiple NAS procedures may terminate in the AMF, it may also be possible to transmit different types of payload or NAS messages that do not terminate at the AMF between the UE and the AMF. In such cases, the AMF may act as a proxy through the MM protocol with encapsulated other contents. The overall functionality of the MM protocol may include many interrelated functions, for example potentially including functions described in further detail in 3GPP TS 23.501 v. 18.1.0 and 3GPP TS 24.501v. 18.2.1 , in some embodiments. FIG. 7 illustrates an example of a control plane stack between a UE 702 and 5G core network in which an AMF 704 may act in such a manner to both terminate certain types of NAS procedures and to act as a proxy to transmit payload and NAS messages that terminate elsewhere in the core network (e.g., session management function (SMF) 706, short message service function (SMSF) 708, policy control function (PCF) 710, location management function (LMF) 712).

As 3GPP 6G development occurs, there may be several trends and drivers for RAN-core convergence. The core network may be increasingly decentralized as the amount of traffic through the core may increase substantially. Network functions may become cloud-native and implemented in local or edge clouds for low-latency services. Network disaggregation may enable software driven implementation of network functions on common-off-the-shelf (COTS) hardware. Some simplifications may be pursued, for example including by combining some of the RAN and core functions into single entities.

The AMF hosts many functions in 5G networks, many of which are enabled through the MM protocols towards the UE. It may be possible that with increasing network scale (e.g., including greater numbers of devices), the functionality hosted by the AMF may become larger than desirable for effective and/or efficient network operation. To leverage the benefits of a service based architecture (SBA) between the RAN and the core and to enable the RAN to communicate with multiple network functions over a service-based interface, it may be helpful to redesign the NAS protocol architecture such as to support distributed NAS protocol terminations across multiple network function (NF) types.

Accordingly, one area of study for 6G network architecture may include the possibility of NAS protocol distribution at the network side. In addition, there may be proposals for combining/integrating certain functionality (or portions of them) of the core network into the RAN. Further, the 6G network may potentially be designed to cope with very high traffic demand triggered by normal and smart devices, and new types of services and new types of devices (potentially including brain-computer interface (BCI) devices, health care devices, etc.) may emerge, while also Internet-of-Things (IoT) traffic may be expected to reach a massive scale. For example, it could be the case that billions of sensors and small IoT devices could require access signaling in a network. Given these considerations, it may be beneficial to identify different types of devices, for example including distinguishing those that do not at all require high throughput and bandwidth from other devices. It may additionally or alternatively be desirable to move some of the NAS functionality from the mobility anchor (e.g., the AMF in 5G) to other network elements, e.g., in order to reduce the processing load on the mobility anchor.

Accordingly, in some embodiments, a light version of the mobility management of NAS may be implemented in certain specific RAN nodes, for example in order to increase the core network flexibility in 6G as well as to allow some sort of migration and integration between the core network and the RAN. It may be the case that this is primarily targeted to servicing devices that are relatively stationary, have no need to have an address to be allocated for the user plane (e.g., an IP address), and/or do not require high bandwidth or throughput. For example, IoT devices deployed in homes or other locations with little or no expected mobility could represent one such possible set of devices. It may be the case that the services used by these devices can be realized using the control plane (e.g., via SMS, as one possibility).

During the establishment of a RRC connection (or similar process), such a device may inform the RAN of its type and/or provide another indication that the device is or may be suitable for distributed NAS termination by the network, based on which the network may be able to determine that it supports the lighter version of mobility management. Once the core network has authenticated the device and a security context has also been established during the registration procedure, the core network may pass the UE's MM-context to the RAN. The MM-context could also contain addressing information of network node(s) for the RAN to contact in the future. It may be the case that the RAN also supports SBA in 6G.

This design may be well suited for devices that do not normally expect any mobile terminated (MT) traffic, at least according to some embodiments. Moreover, since these devices may generally create relatively simple traffic cases, it may be the case that they do not require all of the MM information elements and/or procedures, in which case that RAN node to which the light-weight MM NAS elements are distributed may also not need to support those MM procedures or information elements. Further, the RAN node may not have to support the session management protocol and procedures. In some embodiments, it may be the case that certain MM signaling messages, such as the ones related to network slice specific authentication and authorization (NSSAA) and extensible authentication protocol (EAP) authentication, also need not be supported at the RAN node.

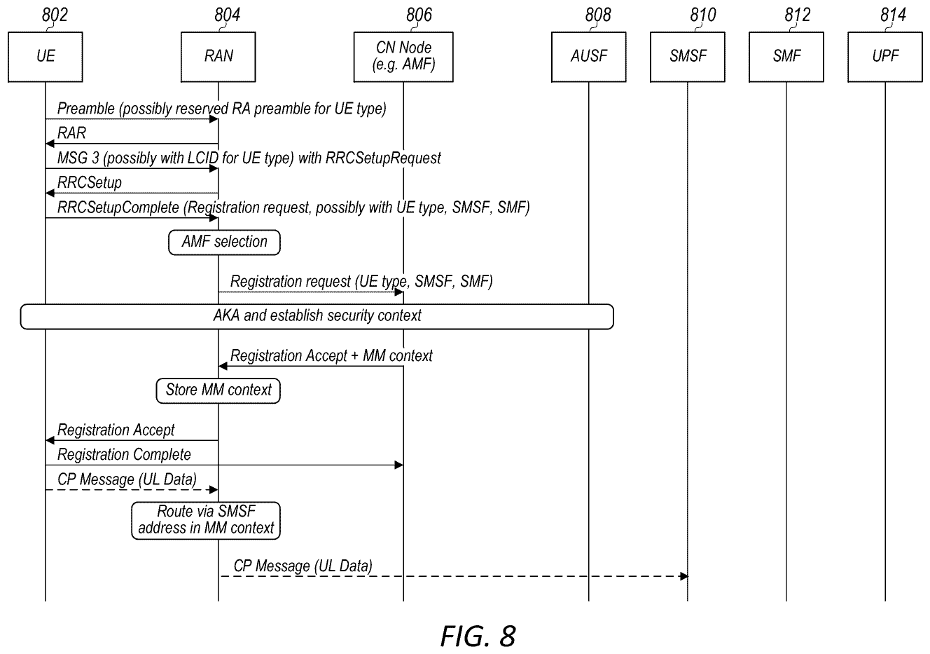

FIG. 8 is a signal flow diagram illustrating exemplary aspects of a possible signal flow for performing uplink communication in a system with distributed non-access stratum termination, according to some embodiments. The system in which the example scenario of FIG. 8 is performed may include a UE 802, RAN 804, core network (CN) anchor node (e.g., AMF) 806, authentication server 808, SMSF 810, SMF 812, and UPF 814. As shown, the UE 802 and the RAN 804 may establish a RRC connection, including performing registration with the core network. The UE 802 may inform the RAN 804 of the UE type and/or otherwise provide an indication that it is or may be suitable for network-side distributed NAS termination. Such information may be included in RRC setup/connection request or RRC setup/resume complete, or through a reserved random access preamble, or a dedicated logical channel identity (LCID) in Msg3/MsgA for RRCSetupRequest, or by using a special radio network temporary identifier (RNTI), or by using a new RRC establishment cause, among various possibilities. In some instances, a new access identity can be introduced for UAC. When sending the registration request message, the UE may also inform the network of the type of service and the node in the network (e.g., SMS and SMSF, as one possibility) that it will want to access. The RAN 804 may select the CN node 806 and inform it of the UE type (or otherwise indicate that it is or may be suitable for network-side distributed NAS termination) when forwarding the registration request message. The CN node 806 and the UE 802 may go through authentication and key agreement (AKA) and establish security context. The CN node 806 may send the MM context (e.g., UE's identity, security context, type of service, network node's address, etc.) to the RAN 804 along with the registration accept message. The RAN 804 may store the MM context and forward the registration accept message to the UE 802.

At some point in the future, as shown, the UE 802 may send user data (e.g., SMS) using the control plane. Since the RAN 804 may have the addressing information of the network node to receive the user data, it may forward it to the responsible node (e.g., SMSF 810, in the illustrated example scenario). Thus, any communication between the UE 802 and the core network for this traffic case may be relayed over the RAN node 804 and the CN anchor node 806 may not be involved. It may be left to implementation choice for the network operator to use the signaling resources between the RAN and the CN, or other means such as IP. If the latter option is used, it may be the case that the IP address points to the RAN node 804 and that the RAN node 804 knows that the IP address is set up for the UE 802.

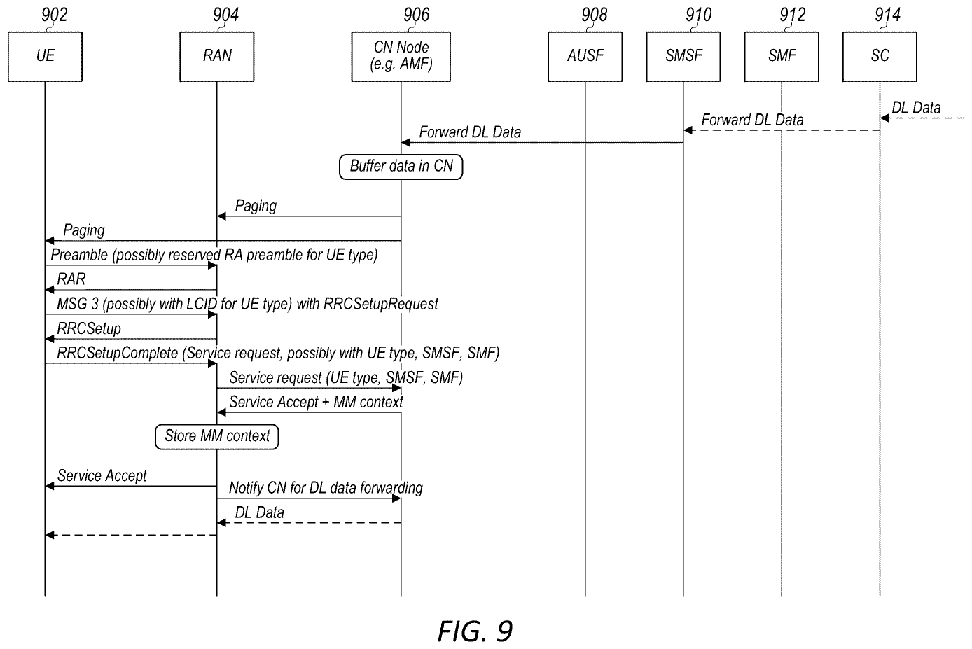

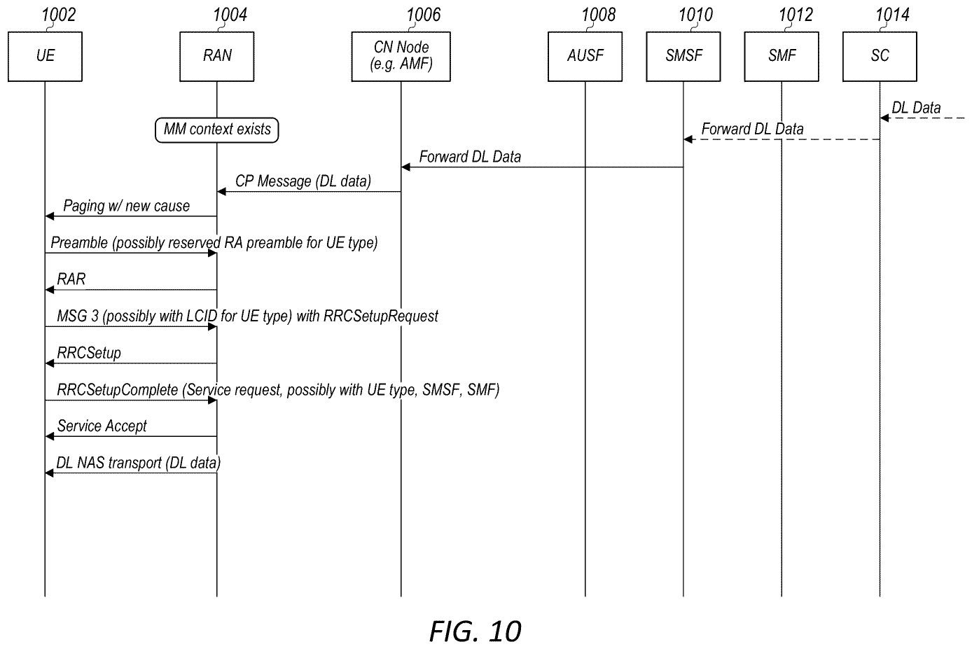

It may also be possible for the core network to send its buffered downlink user data to a UE via the control plane, in some embodiments. FIGS. 9-10 are signal flow diagram illustrating exemplary aspects of possible signal flows for performing such downlink communication in a system with distributed non-access stratum termination, according to some embodiments.

The system in which the example scenario of FIG. 9 is performed may include a UE 902, RAN 904, CN anchor node (e.g., AMF) 906, authentication server 908, SMSF 910, SMF 912, and service center (SC) 914. In this example scenario, the RAN 904 may not yet have MM context information for the UE 902. As shown, downlink data for the UE 902 may be forwarded from the SC 914 through the SMSF 910 and to the CN node 906, where it may be buffered until it can be transmitted to the UE 902. The CN node 906 may perform paging for the UE 902 through the RAN 904, and the UE 902 and the RAN 904 may establish a RRC connection, including submitting a service request to the core network. The UE 902 may inform the RAN 904 of the UE type and/or otherwise provide an indication that it is or may be suitable for network-side distributed NAS termination. As in the scenario of FIG. 8, such information may be included in RRC setup/connection request or RRC setup/resume complete, or through a reserved random access preamble, or a dedicated logical channel identity (LCID) in Msg3/MsgA for RRCSetupRequest, or by using a special radio network temporary identifier (RNTI), or by using a new RRC establishment cause, among various possibilities. When sending the service request message, the UE may also inform the network of the type of service and the node in the network (e.g., SMS and SMSF, as one possibility) that it will want to access. The RAN may inform the CN node 906 of the UE's type (or otherwise indicate that it is or may be suitable for network-side distributed NAS termination) when forwarding the service request message. The CN node 906 may send the MM context (e.g., UE's identity, security context, type of service, network node's address, etc.) to the RAN 904 along with the service accept message. The RAN 904 may store the MM context and forward the service accept message to the UE 902. The RAN 904 may notify the CN node 906 that downlink data forwarding is in place, and the CN node 906 may forward the downlink data to the UE 902 via the RAN 904.

The system in which the example scenario of FIG. 10 is performed may include a UE 1002, RAN 1004, CN anchor node (e.g., AMF) 1006, authentication server 1008, SMSF 1010, SMF 1012, and SC 1014. In this example scenario, the RAN 1004 may already have MM context information for the UE 1002. As shown, downlink data for the UE 1002 may be forwarded from the SC 1014 through the SMSF 1010 and the CN node 1006 to the RAN 1004, where it may be buffered until it can be transmitted to the UE 902. The RAN node 1004 may perform paging for the UE 1002, and the UE 1002 and the RAN 1004 may establish a RRC connection, including submitting and accepting a service request. The UE 1002 may inform the RAN 904 of the UE type and/or otherwise provide an indication that it is or may be suitable for network-side distributed NAS termination. As in the scenario of FIG. 8, such information may be included in RRC setup/connection request or RRC setup/resume complete, or through a reserved random access preamble, or a dedicated logical channel identity (LCID) in Msg3/MsgA for RRCSetupRequest, or by using a special radio network temporary identifier (RNTI), or by using a new RRC establishment cause, among various possibilities. Here, it is also assumed that the MM Context in the RAN 1004 includes certain functionality, such as service request procedure completion. Therefore, when the RAN 1004 receives the service request message from the UE 1002, it can directly reply with the service accept message, hence, not forwarding the message to the CN Node 1006, which may otherwise have been the case if mobility management signaling were entirely centered on the CN node 1006. Since the RAN 1004 already has the MM context and the downlink data for the UE 1002 in this scenario, the RAN 1004 may proceed with DL NAS transport to the UE 1002, potentially without performing any further signaling with the CN node 1006. Note that the downlink data could be included with the service accept message, or could be provided separately.

Note that while the scenarios of FIGS. 8-10 are illustrated and described using at least some 5G based node and message names, use of similar techniques for distributed NAS termination in conjunction with 6G based nodes and/or messages is also envisioned.

In the following further exemplary embodiments are provided.

One set of embodiments may include an apparatus, comprising: a processor configured to cause a radio access network element to: receive information from a wireless device indicating that network-side non-access stratum (NAS) termination for the wireless device can be distributed; provide an indication to a core network anchor node that network-side NAS termination for the wireless device can be distributed; receive mobility management context information for the wireless device from the core network anchor node, wherein the mobility management context information for the wireless device includes addressing information for one or more other core network nodes; receive uplink data from the wireless device; and forward the uplink data directly to at least one of the one or more other core network nodes using the addressing information included in the mobility management context information for the wireless device.

According to some embodiments, the information from the wireless device indicating that network-side NAS termination for the wireless device can be distributed is provided using one or more of: a random access preamble; a radio resource control setup request; a registration request; or a service request.

According to some embodiments, the information from the wireless device indicating that network-side NAS termination for the wireless device can be distributed includes one or more of: use of a random access preamble associated with network-side distributed NAS termination support; logical channel identity (LCID) information associated with network-side distributed NAS termination support; radio network temporary identifier (RNTI) information associated with network-side distributed NAS termination support; radio resource control (RRC) establishment cause information associated with network-side distributed NAS termination support; or wireless device type information associated with network-side distributed NAS termination support.

According to some embodiments, the processor is further configured to cause the radio access network element to: receive information from the wireless device indicating one or more services requested by the wireless device, wherein the one or more services requested by the wireless device are compatible with network-side distributed NAS termination.

According to some embodiments, the mobility management context information for the wireless device includes one or more of identity information, security context information, type of service information, or core network node address information for the wireless device.

According to some embodiments, the uplink data received from the wireless device includes control plane data.

According to some embodiments, the processor is further configured to cause the radio access network element to: receive a service request message from the wireless device; and generate and transmit a service accept message to the wireless device in response to the service request message.

According to some embodiments, the processor is further configured to cause the radio access network element to: store the mobility management context information for the wireless device.

Another set of embodiments may include a method, comprising: by a radio access network element: receiving information from a wireless device indicating that network-side non-access stratum (NAS) termination for the wireless device can be distributed; providing an indication to a core network anchor node that network-side NAS termination for the wireless device can be distributed; receiving mobility management context information for the wireless device from the core network anchor node, wherein the mobility management context information for the wireless device includes addressing information for one or more other core network nodes; receiving uplink data from the wireless device; and forwarding the uplink data directly to at least one of the one or more other core network nodes using the addressing information included in the mobility management context information for the wireless device.

According to some embodiments, the information from the wireless device indicating that network-side NAS termination for the wireless device can be distributed is provided using one or more of: a random access preamble; a radio resource control setup request; a registration request; or a service request.

According to some embodiments, the information from the wireless device indicating that network-side NAS termination for the wireless device can be distributed includes use of a random access preamble associated with network-side distributed NAS termination support.

According to some embodiments, the information from the wireless device indicating that network-side NAS termination for the wireless device can be distributed includes logical channel identity (LCID) information associated with network-side distributed NAS termination support.

According to some embodiments, the information from the wireless device indicating that network-side NAS termination for the wireless device can be distributed includes radio network temporary identifier (RNTI) information associated with network-side distributed NAS termination support.

According to some embodiments, the information from the wireless device indicating that network-side NAS termination for the wireless device can be distributed includes radio resource control (RRC) establishment cause information associated with network-side distributed NAS termination support.

According to some embodiments, the information from the wireless device indicating that network-side NAS termination for the wireless device can be distributed includes wireless device type information associated with network-side distributed NAS termination support.

According to some embodiments, the method further comprises: receiving information from the wireless device indicating one or more services requested by the wireless device, wherein the one or more services requested by the wireless device are compatible with network-side distributed NAS termination.

According to some embodiments, the mobility management context information for the wireless device includes at least wireless device identity information, wireless device security context information, type of service information for one or more services requested by the wireless device, and core network node address information for one or more core network nodes associated with the one or more services requested by the wireless device.

According to some embodiments, the method further comprises: receiving a service request message from the wireless device; determining that the RAN element supports NAS termination for service requested by the service request message; and generating and transmitting a service accept message to the wireless device in response to the service request message.

According to some embodiments, the uplink data received from the wireless device includes control plane data.

Yet another set of embodiments may include a radio access network element, comprising: a network interface; one or more processors; and a memory having instructions stored thereon, which when executed by the one or more processors, perform steps of the method of any of the preceding examples.

A further exemplary embodiment may include a method, comprising: performing, by a device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure may be realized in any of various forms. For example, in some embodiments, the present subject matter may be realized as a computer-implemented method, a computer-readable memory medium, or a computer system. In other embodiments, the present subject matter may be realized using one or more custom-designed hardware devices such as ASICs. In other embodiments, the present subject matter may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus, comprising:
a processor configured to cause a radio access network element to:
receive information from a wireless device indicating that network-side non-access stratum (NAS) termination for the wireless device can be distributed;
provide an indication to a core network anchor node that network-side NAS termination for the wireless device can be distributed;
receive mobility management context information for the wireless device from the core network anchor node, wherein the mobility management context information for the wireless device includes addressing information for one or more other core network nodes;
receive uplink data from the wireless device; and
forward the uplink data directly to at least one of the one or more other core network nodes using the addressing information included in the mobility management context information for the wireless device.

2. The apparatus of claim 1,
wherein the information from the wireless device indicating that network-side NAS termination for the wireless device can be distributed is provided using one or more of:
a random access preamble;
a radio resource control setup request;
a registration request; or
a service request.

3. The apparatus of claim 1,
wherein the information from the wireless device indicating that network-side NAS termination for the wireless device can be distributed includes one or more of:
use of a random access preamble associated with network-side distributed NAS termination support;
logical channel identity (LCID) information associated with network-side distributed NAS termination support;
radio network temporary identifier (RNTI) information associated with network-side distributed NAS termination support;
radio resource control (RRC) establishment cause information associated with network-side distributed NAS termination support; or
wireless device type information associated with network-side distributed NAS termination support.

4. The apparatus of claim 1, wherein the processor is further configured to cause the radio access network element to:
receive information from the wireless device indicating one or more services requested by the wireless device, wherein the one or more services requested by the wireless device are compatible with network-side distributed NAS termination.

5. The apparatus of claim 1,
wherein the mobility management context information for the wireless device includes one or more of identity information, security context information, type of service information, or core network node address information for the wireless device.

6. The apparatus of claim 1,
wherein the uplink data received from the wireless device includes control plane data.

7. The apparatus of claim 1, wherein the processor is further configured to cause the radio access network element to:
receive a service request message from the wireless device; and
generate and transmit a service accept message to the wireless device in response to the service request message.

8. The apparatus of claim 1, wherein the processor is further configured to cause the radio access network element to:
store the mobility management context information for the wireless device.

9. A method, comprising:
by a radio access network element:
receiving information from a wireless device indicating that network-side non-access stratum (NAS) termination for the wireless device can be distributed;
providing an indication to a core network anchor node that network-side NAS termination for the wireless device can be distributed;
receiving mobility management context information for the wireless device from the core network anchor node, wherein the mobility management context information for the wireless device includes addressing information for one or more other core network nodes;
receiving uplink data from the wireless device; and
forwarding the uplink data directly to at least one of the one or more other core network nodes using the addressing information included in the mobility management context information for the wireless device.

10. The method of claim 9,
wherein the information from the wireless device indicating that network-side NAS termination for the wireless device can be distributed is provided using one or more of:
a random access preamble;
a radio resource control setup request;
a registration request; or
a service request.

11. The method of claim 9,
wherein the information from the wireless device indicating that network-side NAS termination for the wireless device can be distributed includes use of a random access preamble associated with network-side distributed NAS termination support.

12. The method of claim 9,
wherein the information from the wireless device indicating that network-side NAS termination for the wireless device can be distributed includes logical channel identity (LCID) information associated with network-side distributed NAS termination support.

13. The method of claim 9,
wherein the information from the wireless device indicating that network-side NAS termination for the wireless device can be distributed includes radio network temporary identifier (RNTI) information associated with network-side distributed NAS termination support.

14. The method of claim 9,
wherein the information from the wireless device indicating that network-side NAS termination for the wireless device can be distributed includes radio resource control (RRC) establishment cause information associated with network-side distributed NAS termination support.

15. The method of claim 9,
wherein the information from the wireless device indicating that network-side NAS termination for the wireless device can be distributed includes wireless device type information associated with network-side distributed NAS termination support.

16. The method of claim 9, wherein the method further comprises:
receiving information from the wireless device indicating one or more services requested by the wireless device, wherein the one or more services requested by the wireless device are compatible with network-side distributed NAS termination.

17. The method of claim 9,
wherein the mobility management context information for the wireless device includes at least wireless device identity information, wireless device security context information, type of service information for one or more services requested by the wireless device, and core network node address information for one or more core network nodes associated with the one or more services requested by the wireless device.

18. The method of claim 9, wherein the method further comprises:
receiving a service request message from the wireless device;
determining that the radio access network element supports NAS termination for service requested by the service request message; and
generating and transmitting a service accept message to the wireless device in response to the service request message.

19. The method of claim 9,
wherein the uplink data received from the wireless device includes control plane data.

20. A radio access network element, comprising:
a network interface;
one or more processors; and
a memory having instructions stored thereon, which when executed by the one or more processors, cause the radio access network element to perform operations comprising:
receiving information from a wireless device indicating that network-side non-access stratum (NAS) termination for the wireless device can be distributed;
providing an indication to a core network anchor node that network-side NAS termination for the wireless device can be distributed;
receiving mobility management context information for the wireless device from the core network anchor node, wherein the mobility management context information for the wireless device includes addressing information for one or more other core network nodes;
receiving uplink data from the wireless device; and
forwarding the uplink data directly to at least one of the one or more other core network nodes using the addressing information included in the mobility management context information for the wireless device.
